(19) United States
(12) Patent Application Publication
(10) Pub. No.: US 2023/0229986 A1
(43) Pub. Date: Jul. 20, 2023

(54) Machine Learning Based Construction Methods, Techniques, and Algorithms

(71) Applicant: CONSTRUCT A.I. INC., Carlstadt, NJ (US)

(72) Inventors: Jasmin Cami, Closter, NJ (US); Michael Espinosa, Washington Township, NJ (US)

(73) Assignee: CONSTRUCT A.I. INC., Carlstadt, NJ (US)

(21) Appl. No.: 18/009,548

(22) PCT Filed: Jul. 28, 2021
(86) PCT No.: PCT/US2021/043406

§ 371 Date: Dec. 9, 2022

Related U.S. Application Data
(60) Provisional application No. 63/057,609, filed on Jul. 28, 2020.

(51) Int. Cl. G06Q 10/0631; G06Q 50/08; G06Q 20/10

(52) U.S. Cl. CPC G06Q 10/063114; G06Q 50/08; G06Q 20/102; G06Q 10/06312; G06Q 2220/00

(57) ABSTRACT

Techniques to automate various aspects related to construction projects, including but not limited to, creation of schedules, verification of construction progress, estimation of costs, updating of schedules, creation and estimation of construction status, use of information generated by construction equipment, and the use of granular information to continually update the same. Data analysis can be used to refine the cost per task and calculate a cost to complete for a construction project. The cost to complete can be viewed at any time and it will be made more accurate by having the cost per task refined from historical data. Additionally, a rate of production statistic can be generated to compare workers across tasks and see if the implicit task durations used to today can be refined. A learning algorithm can be created by using reinforced learning to figure out the next best step if a project task is delayed or put on hold. This action can normalize projects in an effort for them to complete as scheduled and priced.

### CROSS-REFERENCE TO RELATED APPLICATIONS

The present application is a national phase entry under 35 U.S.C. § 371 of International Application No. PCT/US2021/043406, filed Jul. 28, 2021, which claims priority from U.S. Provisional Application No. 63/057,609, filed Jul. 28, 2020, all of which are incorporated herein by reference.

### BACKGROUND

Construction projects have several aspects which create difficulty in estimating costs of completing a construction project. The cost of completing a construction project can be estimated as the sum total of all human and material costs that are involved in any given project. In addition, the difficulties in estimating costs to completing a construction project are evolving throughout the project, and a dynamic mix of factors extrinsic to the construction project, such as material costs, labor costs, labor availability, social and political conditions, and risks of various types. Examples of such projects include both residential and commercial construction projects, such as housing, office buildings, hotels, or special purpose construction.

In addition to the above complexities, it is hard to quantify the progress within a construction project. Gauging the amount of progress within a construction project often reflects the subjective experience of construction site managers. As one example, the skill level, motivation, and output of a construction laborer is highly variable but has a large impact on a project schedule and cost. For example, a construction site supervisor may be able to rely on his or her experience in construction to estimate or quantify the amount of work done towards completing a construction project. However, such experience is subjective, not quantifiable, and cannot be used to algorithmically determine aspects or make accessible to others the progress of a construction project. In addition, such human based estimations are often inherently inaccurate, based on a visual inspection of a construction site, and cannot ensure that all construction project parameters have been complied with. Even when circumstances can put a certain construction task on hold, the project is rescheduled manually with delays. The delays in projects cause loss of resources and revenue. Currently, rescheduling is done manually and is highly dependent on the experience and efficiency of the supervisor of the project.

Further, the planning or development of construction projects, order of activities in a construction project, and scheduling of events in a construction project is often related to variables which rely on human or manual estimations of costs, development, and experience. The aforementioned estimates cannot be updated by humans in real time, based on external data, or guarantee an optimal solution at every point of time in the evolution of a construction project.

Further, the interpretation of construction related information, schedules, costs, and estimated time and cost to completion of a phase or the entire construction project is obfuscated, inaccessible, or undecipherable to other organizations or individuals who may be interested in or have financial interests in the construction project, such as banks, investors in the construction project, a client or buyer of the construction project. This is so, as information related to construction projects is not easily understandable to those outside of having a specific construction expertise. In addition, such information is hard to quantify or readily make available in updatable or machine readable formats.

Current solutions to the above difficulties rely on unquantifiable and subjective estimations made by humans responsive to specific inquiries related to a construction project. This leads to inaccurate, out-of-date, or incomplete information about a construction project. As one example, information is currently reviewed on a monthly basis. Thus, certain issues related to a construction schedule will not be recognized or identified for three to four weeks. Further, it takes another two to three weeks to address the issue. In addition, even software based solutions can assist in future planning, but are not responsive, do not use live data, and thus inevitably become stale, out of date and not useful.

Thus, it is desirable to provide technologies which can improve workflow related to construction projects, including but not limited to, creation of schedules, verification of construction progress, estimation of costs, updating of schedules, creation and estimation of construction status, use of information generated by construction equipment, and the use of granular information to continually update or tune the same.

### SUMMARY

The present disclosure provides technologies related to various aspects of construction projects. Aspects described herein can be performed as methods, stored on computer readable medium, or be performed on systems.

Aspects of the technology disclosed include a method, the method comprising selecting, one or more parameters related to a construction activity; receiving, by one or more processors, a current condition of a construction project; receiving, by at least one smarttool information related to at least one selected parameters; determining, by one or more processors, a cost to completion of the construction project wherein the determination is based on at least one of: (i) a machine learning algorithm, (ii) a generative adversarial network, or (iii) a trained neural network; determining, by the one or more processors, a schedule of tasks related to the construction activity; determining, by the one or more processors, instructions related to the determined schedule of tasks wherein the instructions are machine-readable; sending, from the one or more processors, instructions to an autonomous construction apparatus, wherein the apparatus is one of a (i) robot or autonomous construction equipment; sending, from the one or more processors, the cost to complete the construction activity to a user device; and wherein the one or more processors are configured to be in a data communication with a smart construction device.

Aspects of the disclosed technology can comprise methods, systems, and computer readable medium.

Aspects of the technology disclosed include a method, the method of determining a completion metric for a construction activity. The method can comprise receiving, by one or more processors, a current condition of a construction project; determining, by the one or more processors, from possible tasks, a scheduled sequence of tasks to complete the construction activity; evaluating, by the one or more processors, a current status of at least one task from the schedule of tasks; and computing, by one or more processors, the completion metric for the construction project based on the current condition of the construction project and the current status of at least one task from the schedule sequence of tasks. Determining can be made based on at least one of: (i) a machine learning algorithm, (ii) a generative adversarial network, or (iii) a trained neural network. The completion metric can be updated upon receiving an indication that a task from a schedule of tasks is completed. The completion metric can be updated upon receiving an indication that a task from a schedule of tasks cannot be completed. The scheduled sequence of tasks related to the construction activity can be updated. A smart contract can be associated with one or more tasks from the scheduled sequence of tasks. The smart contract can be executed upon completion of a task within the scheduled sequence of tasks. Execution of the smart contract can pay an entity associated with the completion of the task within the scheduled sequence of tasks. Verification of completion of a task from the scheduled sequence of tasks can be based on data obtained from a smart tool. Verification of completion of a task from the scheduled sequence of tasks can be based on data generated using a computer vision technique. A work block for each task from the one or more schedule of tasks can be generated. The completion metric can be a cost to complete or a time to complete the construction activity. Evaluating the current task can be based on information received from a construction device, smarttool, data generated from a natural language interpretation algorithm, or data generated from a machine vision algorithm. Revising the sequence of tasks can take place upon evaluation of the current task. Revision of the sequence of tasks can be performed by an experimentation agent.

Aspects of the disclosed technology can comprise a system. The system can comprise one or more processors coupled to a memory, the memory containing instructions to determine a completion metric for a construction activity, the instructions when executed configured to perform the steps of: selecting, one or more parameters related to a construction activity; receiving, by one or more processors, a current condition of a construction project; determining, by the one or more processors, from possible tasks, a scheduled sequence of tasks to complete the construction activity; evaluating, by the one or more processors, a current status of at least one task from the schedule of tasks; and computing, by one or more processors, the completion metric for the construction project based on the current condition of the construction project and the current status of at least one task from the schedule sequence of tasks.

Aspects of the disclosed technology can comprise a method of generating a completion metric related to a construction project by using a trained neural network. The method can comprise receiving, in an input layer of the neural network, one or more inputs related to the construction project, the one or more inputs including at least information obtained from (i) a smarttool or (ii) a machine vision algorithm; evaluating, through a middle layer, the received one or more inputs; and outputting, in an output layer, one or more outputs from which a completion metric can be generated, the one or more outputs comprising at least one of (i) an end date or (ii) estimated remaining work hours. The trained neural network can be trained on historic data related to the output layer to generate weights for connections between the input layer and the middle layer and between the middle layer and the output layer. The trained neural network can be chosen based on the type of construction project. A completion metric can be generated by evaluating all outputs of the output layer.

The completion metric can be generated upon completion of a work block, a task, or a sub-task.

These and other features, aspects, and advantages of the present disclosure will become better understood with regard to the following description, and accompanying drawings.

### BRIEF DESCRIPTION OF THE DRAWINGS

FIG. 1 is an example network according to aspects of the disclosure

FIG. 2A is a flowchart depicting an example method according to aspects of the disclosure.

FIGS. 2B-2E are example user interfaces according to aspects of the disclosure.

FIG. 2F is an example schematic of a remote viewing system according to aspects of the disclosure.

FIG. 2G is an example autonomous robot according to aspects of the disclosure.

FIG. 3 is an example computing device according to aspects of the disclosure.

FIG. 4 is an example architecture according to aspects of the disclosure.

FIG. 5 is an example machine learning model according to aspects of the disclosure.

FIG. 6 is an example of workflows generated using adoption through the experimentation agents.

### DETAILED DESCRIPTION

Overview

The present disclosure provides technologies related to various aspects of construction projects.

Aspects of the current disclosure include intelligent workflow generation and metrics related to the workflow and construction projects based on updatable parameters (e.g., tasks, sub-tasks, weather, workers, resources, tools).

A current condition of a construction project can be the number of tasks completed from a scheduled sequence of tasks and/or a metric related to the one or more tasks completed from the scheduled sequence of tasks.

A construction activity can be, for example, a completion of a room, a building, a series of buildings, or another discrete construction activity, such as installation of a gate. A scheduled sequence of tasks can be a sequence of tasks wherein each task can be related to another task or be independent of another tasks, and each task is assigned to a particular time in which it is to be completed or expected to be completed. The tasks can collectively form the steps required to finish the project. Any arbitrary granularity of tasks is possible and any task can be divided into sub-tasks. For example, if tiling a floor is a task, each tile to be inserted on the floor to complete the tiling of the floor can be a sub-task.

A status of a task can be a quantitative or qualitative description of the task. In some examples, a status of a task can be provided by a human operator reviewing a task such as a supervisor on a construction site. The supervisor can indicate that a particular task (e.g., complete bathroom) is complete. In some examples, the supervisor can provide natural language comments such as “bathroom complete except for finish on sink” and the language can be interpreted by a language interpretation algorithm to provide an indication of what is left, what sub-task is not yet completed (e.g., “sink installation,”) and also quantify what percentage of the task (e.g., complete bathroom) is left. The quantification can be based on any algorithm. For instance, the expected number of hours left to complete the task versus the total number of hours allocated or expected for the task can be used to determine what percentage of the “complete bathroom” task is left. In other examples, the status can be provided or obtained from a machine vision algorithm. In some examples, the expected status can be provided from data obtained from smarttools and later verified by a human operator or secondary review by a machine vision module before the task is considered to be complete.

For instance, it may be known what quantity of paint is required for a bathroom, and a smarttool (e.g., a smart paint machine) can inform what quantity of paint has been sprayed. An estimated status for the tasks can thus be generated. A human operator or machine vision algorithm can verify that the task or subtask is actually complete and that the paint has been applied to the correct surfaces.

As one example, a construction project can be received and from the construction project, a list or sequence of tasks can be generated. Further, the current condition of the construction project can be obtained or determined. For example, the current condition can be stored in a database. In some examples, the current condition can be generated based on information related to every task related to the construction project. In some examples, information or data related to each task can be obtained from the various examples further described herein, including but not limited to, smarttools, verification of a task by a supervisor, an autonomous or semi-autonomous robot, or a machine vision module. In other examples, a natural language interpret can be used to interpret comments or description related to a task by a human operator, such as “task is complete,” or “double check drywall fit.” The data can be provided to update the current condition of a construction project. In addition, the status of a task which is currently being performed (e.g., drywalling) can be actively or periodically monitored for completion. As updates are obtained related to one or more active tasks, a completion metric can be updated. A completion metric for the construction project can be generated based on any of (i) the scheduled sequence of tasks, (ii) the current condition of the construction project, and (iii) at least one task from the schedule of tasks. In some examples, the inter-relationship between tasks in the schedule of tasks can be considered in determination of the completion metric.

In some examples, the completion metric can be a cost to complete the construction project. Other information related to the construction project can also be generated, such as time remaining. Various non-limiting examples of completion metrics can include time to complete, cost to complete, material cost to complete, labor cost to complete, and completion risk. In some examples, constraints can be added on the construction project which can affect the schedule of tasks. For instance, if a project must be completed more promptly or in a smaller time frame, the sequenced schedule of tasks can be updated. The completion metric can be updated for the new sequenced schedule of tasks. In other examples, if a delay or impossibility to complete a particular task, due to material or labor shortage, or other delays (e.g., weather, zoning changes, permitting issues), the algorithm can update the completion metric. In some examples, the completion metric can be updated daily or hourly.

In some examples, the schedule of tasks can be updated based on information from the environment or indications that a particular task cannot be completed. In other examples, if a particular task becomes too costly, it can be attempted to be replaced with another task. In some examples, the schedule of tasks can be generated using a machine learning algorithm, such as, for example, through one or more experimentation agents. Other algorithms include genetic algorithms, reinforcement learning, hybrid deep neural network methods, neural networks, generative adversarial networks, or heuristic optimization methods. The generation of tasks can be done in non-brute force computation, non-polynomial time, or in a time that is computationally feasible to provide real-time or near-real time updates to the schedule of tasks and completion metrics. In some examples, additional inputs can be taken based on the available resources (materials available, workers available, weather, and equipment available).

In the examples described herein, information can be sent to a computer via input from a user device, and multiple inputs from multiple users (e.g., multiple workers on a job site) can be aggregated or stored on a database for analysis. In other examples, a completion metric can be provided to a user device. In some examples, specific completion metrics can be derived from other completion metrics.

In some examples, each task can line up with a building product, a worker assigned to the task, or a division. A cost database can also be maintained and continuously updated with unit cost or actual costs. The database can also be used when generating payouts for completing certain tasks and receiving bids on smart contracts. Machine learning can also be applied to data collected for (i) task unit costs, (ii) task completion times, (iii) task/worker combination, (iv) logistics (e.g., vendor, weather, site access), and (v) tool usage.

For instance, an example of the disclosed technology may comprise a project that involves multiple tasks (as discussed above) that must be completed by a given time and for a given budget. The project may involve a starting point (e.g., pour the foundation) and a start date. Once the foundation is poured, coordination of multiple tasks involving multiple resources must be accounted for and sequenced so that the projection completion time and/or costs are met. The multiple or possible tasks may comprise all the tasks involved in a construction project, e.g., pouring the foundation, getting a crane on site, building the frame, putting in sheetrock, plumbing, floors, etc. However, interrelationship between different tasks may impact completion time and costs. As the number of tasks increase, tracking them and how they may impact each other gets beyond human capability and state of the art known computing tools. An aspect of the disclosed technology takes the information related to tasks and other parameters as input and dynamically tracks the progress of the project and updates the completion costs, time or other metrics that may be used to monitor progress or goals. For instance, once the foundation is poured, welding may need to be done to establish the frame of the building. The site may be monitored and the progress of building the frame may be monitored based on the rate at which welding materials are being used (e.g., 50% of the welding materials used based on productivity detected through use of welding equipment). The progress may then be used to update the tasks to be performed, their sequence, whether additional resources need to be brought on board, etc.

Projects can also be managed remotely by using a digital schedule and assigning the generated schedule of tasks to workers manually or remotely. Workers can receive their tasks directly. Workers can further provide information related to the task at hand (e.g., self report completion or issues) which can be analyzed using natural language interpretation algorithms. Workers can also upload a picture or video when they think a task is complete which can be analyzed by a supervisor or through a machine vision algorithm. A worker can also receive an indication that the task is verified as completed and subsequently receive a new task. A worker can also receive reminders about his or her progress or report delays which can be used to adjust or update an expected completion metric. In other examples, data can be provided by a worker through a smart glasses or wearable devices.

In some examples, work blocs can be further broken down into assignable actions or sub-tasks, which can be assigned resources and scheduled with start and end dates.

Aspects of the disclosed technology include a cost-to-complete algorithm or completion metric algorithm. The cost-to-completion algorithm can be implemented using machine learning, clustering, generative adversarial network, neural networks, deep learning, gaussian predictors, or other related artificial intelligence techniques. In one example, the cost-to-complete algorithm can provide one or more metrics related to completing a construction project based on at least a current time. In other examples, the metrics can be cost, efficiency, total time, total manpower, or other parameters of the construction project.

Additional aspects of the disclosed technology provide any combination of the following: automatic scheduling based on historical data related to a tasks, project, construction site, specific details related to the site (such as weather, location, local holidays), skill level of workers, equipment availability and level; tasks related to a construction project being updated in a user application so that progress of a construction project can be updated in real time, allowing issues to be identified and delays in a construction projects to be minimized; real-time cost to complete algorithms, displayed and/or updated in real time as particular tasks related to a construction site are completed; allowing workers to scan in or provide information in real-time from a construction site related to a particular task or project, which can be processed algorithmically; update construction project schedules, tasks, and timelines; translate construction related information to external facing information such as through the use of metrics, matrices, machine learning based translation technologies, or other algorithms; the use of smarttools to record and store the usage of tools as inputs to algorithms and/or to verify other inputs from sources; tracking work productivity and updating the productivity after each tasks is efficiency to distribute and/or match workload and tasks to different workers or resources; the use of smart contracts to automate payments as tasks are completed; the use of blueprints for a project in a user application and the use of augmented reality or virtual reality overlays on the blueprint to provide functionality related to the progress of a project; the ability to verify the completion of a task using robots, autonomous, or semi-autonomous artificial intelligence workers; the ability to automate certain tasks using robots, autonomous, or semi-autonomous artificial intelligence workers.

In other examples, the technology may assist in the creation of construction schedules or providing construction schedules. Aspects of the technology can also be used during the project estimating phase. For example, aspects of the technology may be used by architecture firms who want real time or near real time construction estimates for their designs. Designs can be provided by an architect, which can include for example, the size, types of materials, start of construction, end of construction date, or structural aspects of the design. The algorithm can provide an estimate of the cost of the design to the firm. In some examples, Revit can be used by architects to generate a 3D model. Cost related information for each 3D component in a model, and other algorithms can be used to generate a cost estimate for the 3D construction model provided.

In other examples, the technology may assist in the creation of one or more suggestions which can be generated or provided to construction project managers or other users. In some examples, a cost-to-complete algorithm may have one or more aspects which are generated in response to a current condition of a construction project. In some examples, the alerts can be chosen or acted upon by project managers or end users. In some cases, the alerts can provide a plurality of choices to a user. The choices, and the alerts, can be actionable. In some examples, the actionable alert can be integrated or cause an autonomous or semi-autonomous construction equipment to take action. In other examples, aspects related to the construction project, such as scheduling of labor, hiring of more workers, or ordering of materials or equipment can be performed automatically based on the generated alerts.

In yet other examples, the algorithm can be customized, tweaked, or be trained to produce more specific or tailored recommendations based on local legal, construction, or requirements made by the company performing the construction or receipt of a construction project.

In yet other examples, the algorithm can optimize for one aspect of a construction project, such as speed of the construction, total cost of the construction, or the use of particular types of materials within the project, such as, for example, eco-friendly materials, fire proof materials, or thermally resistive materials.

In yet other examples, according to aspects of the technology, one or more algorithms can use information generated by one or more autonomous, semi-autonomous, or human augmenting equipment. One example of a human augmenting piece of equipment is the EksoZeroG arm and EskoVest from Ekso Bionics. The aforementioned pieces of equipment can communicate to a device dedicated to the construction site over communication interfaces, such as bluetooth, Wi-Fi, or other standards.

Other aspects of the technology provide for methods to allow a construction project to be algorithmically described as discrete blocks of tasks (“work blocks”). In some examples a work block can be a task or sub-task as described herein, and vice-versa. Each work block can be related to one or more smart contracts. In some examples, the completion of a work block can be verified using aspects of the technology disclosed herein. The smart contract can be enabled to allow the contract to be “paid” upon the completion of the work block. In yet other examples, the work block can be divided into sub-blocks. The completion of the sub-block can be verified according to one or more aspects of technology disclosed herein. Upon completion of the sub-block, a portion of the smart contract can be “paid” to the constructor of the construction project.

In some examples, aspects of the technology disclosed herein can be implemented in part or on whole on user devices through an application on the user device. As explained further below, the user device can be in data communication with one or more servers.

In some examples, a virtual or augmented reality blueprint can be superimposed onto a construction site. This can allow for supervisors to show workers where to work directly on their mobile device. Also, supervisors can highlight what part of the drawing the worker needs to work on.

In some examples, aspects of the construction project can be incorporated into a blockchain. In some examples, cryptocurrency or other forms of digital payment can be used for payment of smart contracts. Smart contracts can be configured for payment of funds upon completion of a work block described in the smart contract and verification of the work block through the methods and techniques described herein.

As used in this disclosure and in the Figures, Work Blocs® can refer to a work block, as further described herein, and vice versa. Similarly, as used in this disclosure, cost to complete can be understood to include other completion metrics, such as, for example, time to complete, risk to complete, or probability of completion.

### Example Systems and Methods

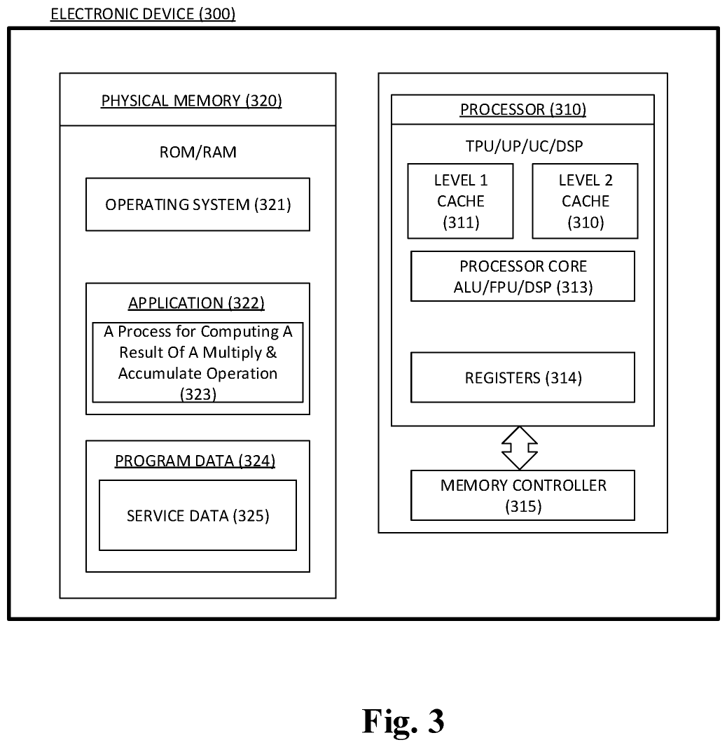

Aspects of the technology disclosed herein, such as those described with reference to the Figures contained herein, can be performed via an electronic device, such as that described with respect to FIG. 3 for example.

An electronic device may be any type of wearable electronic device, such as smart watches, glasses, or the like. Alternatively, the electronic device may be a non-wearable electronic device such as a mobile phone, laptop, tablet, personal digital assistant (“PDA”), or the like.

The electronic (or computing) device may have an internal set of components including a processor, memory, a user interface, and a display. The processor can include one or more computer processors, such as a central processing unit (“CPU”) and/or a graphical processing unit. These computer processors are designed, in part, to receive information from a user interacting with the user interface and then displaying the information through the user interface. The processor may additionally operate in tandem with other types of hardware circuitry, such as application-specific integrated circuits, controllers, or the like. As an example, the graphical processing unit may display a prompt on the display an example construction schedule according to aspects of this disclosure.

The user interface may receive inputs from a user through the user's interactions with the electronic device and then can convert those inputs for use by the processor. These inputs may be received by any one, or combination, of a variety of input devices, such as a touch screen, mouse, key input, stylus, microphone, or the like. For instance, the prompt to turn on or perform a certain action on a device may appear on the display. The user may tap on the displayed button with a finger or stylus, and the tap can then be converted for use by a processor. The processor may then run an application related to changing the device status of the electronic device using instructions and data stored in the memory to cause the device to perform aspects of this disclosure.

In some examples, the user interface may display one or more of the following: a cost to complete table, working hours remaining per task, current tasks a project baseline, upcoming project tasks, an augmented reality overlay (such as a task verification overlay, upcoming tasks overlay, etc.).

The memory can be one or more of a computer-readable medium or media, or a volatile/non-volatile memory unit or units, such as flash memory, random-access memory, or the like. Alternatively, the memory may be in the form of CD-ROMs, DVDs, high-density tape drives, and other types of memories. In one instance, the memory may contain a computer program or application containing instructions that, when executed by one or more processors, performs one or more methods as those described herein. In this regard, the terms “instructions,” “programs,” or “applications” may be used interchangeably herein. The instructions may be stored in an object code format for processing by one or more processors. Alternative computing device language may include collections of independent source code modules or scripts that can be either compiled in advance or interpreted on demand. The instructions may be executed by the processor(s) directly (e.g., through machine code or the like) or indirectly (e.g., through scripts or the like). The methods and functions of the instructions are explained in more detail below.

The electronic device can additionally include a communication module for communicating with other devices or systems, and may include a wireless or wired transceiver. Through the communication module, the electronic device can communicate with other devices using a number of configurations and protocols. This includes short range communication protocols such as the Internet, intranets, virtual private networks, Ethernet, WiFi and HTTP, wide area networks, local networks, private networks using communication protocols proprietary to one or more companies, near-field communication, Bluetooth™, Bluetooth™ Low Energy (“BLE”), or other ad-hoc networks, and/or a combination of the above.

In certain instances, an electronic device may be connected to a number of other devices through a network to communicate the device status of the electronic device and to determine whether there is a shared characteristic among the devices. The other devices do not have to be the same type as the electronic device. For example, the electronic device may be a mobile phone while the other devices may be a tablet, laptop, smartwatch, PDA, or any device as mentioned above. This network may be connected to a server that can provide information to the devices connected to the network from a database connected to the server. The database securely stores data such that only authorized access is permitted. Additionally, personally identifiable information related to the device's user and/or connected devices, such as names, addresses, contact information, or the like, may be removed, and the data may instead be labeled and identified using a random or pseudo-random code, identifier, or other form of anonymous identification. Any of the devices in the network may send requests and receive query results from the server. For instance, the electronic device may send a query as to which of the other devices in the network share the same event invite. The server may employ the methods as described herein, and includes modules and components similar to those described for the electronic device above, including having instructions for implementing methods described herein.

The computing device components as described are not limited to being all stored within the same physical housing. As an example, the instructions may alternatively be stored on a read-only computer chip, or a removable storage medium, such as a universal serial bus drive, optical drive, high-density tape drive, or the like.

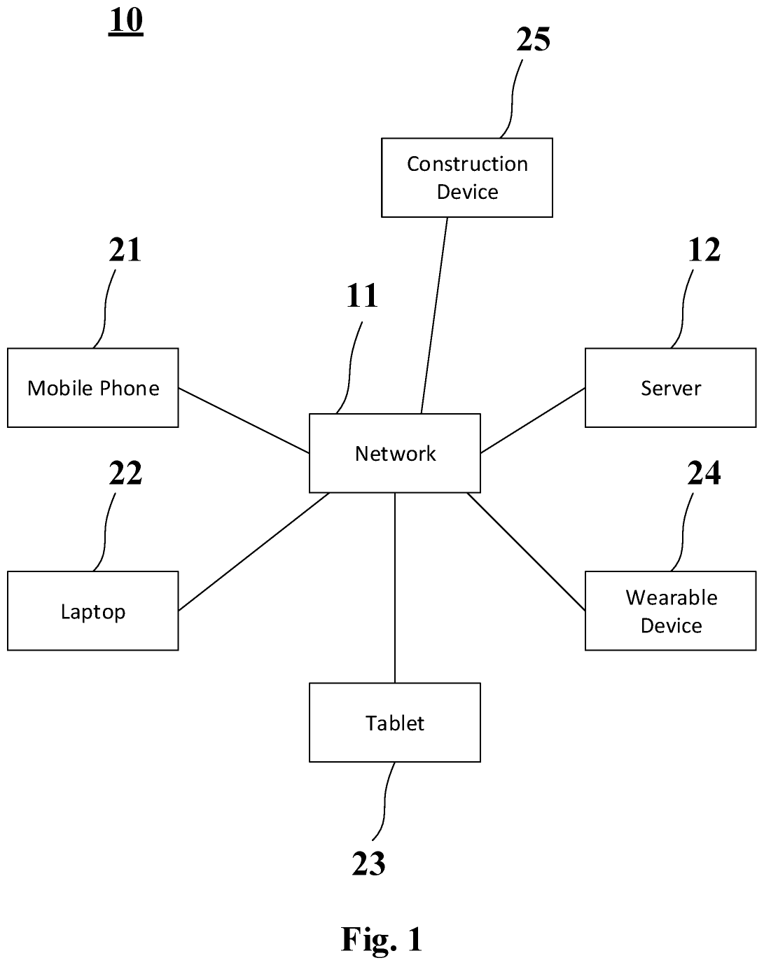

FIG. 1 depicts an example system 10. System 10 includes network 11 connecting a plurality of devices, including mobile phone 21, laptop 22, tablet 23, wearable device 24, and server 12. The devices may have a communication module, as described above, to allow each device to communicate with another device. Alternatively, server 12 may house the instructions to perform the disclosed method. In this instance, tablet 23 may have an application or program installed that enables server 12, through an option enabled by the user, to access tablet 23 to, for example, detect the device status of laptop 22, determine whether laptop 22 has a shared characteristic and device status with tablet 23, and send a prompt to wearable laptop 22. In alternative aspects, system 10 may include any number of devices, including multiples of each type of device (e.g., multiple mobile phones 21 connected to network 11, or other network arrangements).

Construction device 25 can include any piece of equipment which is used during construction of a construction project. In some examples, communication access can be provided across a construction work site through the use of for example, Wi-Fi. For example, any piece of equipment which has the capability of transferring information over a network or communication medium, such as a saw, a drill, an impact driver, a screwdriver, or other power tools can all be examples of construction device 25. In other examples, construction device 25 can be specialized scanning or visual equipment to autonomously or semi-autonomously take measurements of a construction site, and provide that information to server 12. In some examples, this can be an overhead drone which can for example, take a scan or pictures of a roof. In other examples, it can be an autonomous robot which scans for particular materials, such as screws within sheetrock, to provide information to verify that a particular construction task has been completed.

In yet other examples, construction device 25 can provide information as it is being used, such as in the case of an automated sheet-rock installation robot. In some examples, construction device 25 can be a “smarttool.” In some examples, a smarttool can be any construction tool that provides data to a computer for analysis via a connection. As an example, a smarttool can be a nailgun that indicates how many nails have been fired. A smart tool can contain multiple sensors to provide more sophisticated information for analysis. For instance, a nailgun may indicate the type of nail fired, the orientation at which it was fired, the speed of firing, the motion or movement of the nozzle between nails, any clustering of the nails etc. In some examples, construction device 25, such as for example a communication connected tool or smarttool, as described herein, can also include an identification of a user using the device through biometrics, a pin code, or a job code, to indicate the user using the device, the type of task, sub-task, or job the device is being used for. In other examples, each construction device can communicate regarding how often it is used, or the number of events associated with the device. For instance, construction device 25 can indicate the number of nails installed when it is a nail gun. In other examples, a particular task can be associated with a certain number of actions on construction device 25, such as a number of nails, screws, or other events or activities. In other examples, the gallons of paint spraying through a spray gun when a device is on a particular work site, or the number of hours of use of a saw or drill, or other power tools, can be obtained from a smart device.

In other examples, devices on workers, such as a fitbit, can also provide information which can be included in the methods below.

In some examples, the server 12 can receive various types of information from one or more devices connected directly or indirectly in example system 10. In one example, the server can receive information from a piece of equipment used for construction, such as an autonomous robot, a smart watch tracking activity (e.g., a fitbit), smart device (such as a smart hammer, a smart drill, or other smart piece of construction equipment), or augmentation tool, such as the EksoZeroG arm and EskoVest from Ekso Bionics. This equipment can produce information which can be integrated into the methods related to aspects of construction-related algorithms, described below.

In some examples, server 12 can receive images, videos, scans, or other information related to construction sites. Server 12 can contain algorithms within instructions to process such information to use as input to the methods described herein.

Aspects of this disclosure can be implemented in a variety of use cases. Examples of certain use cases are discussed herein, such as those described, although the technology may be employed in other situations and is not limited to those expressly provided herein.

An example of use may be included to provide an accurate cost to complete in real time or updated at fixed time intervals for a project in progress.

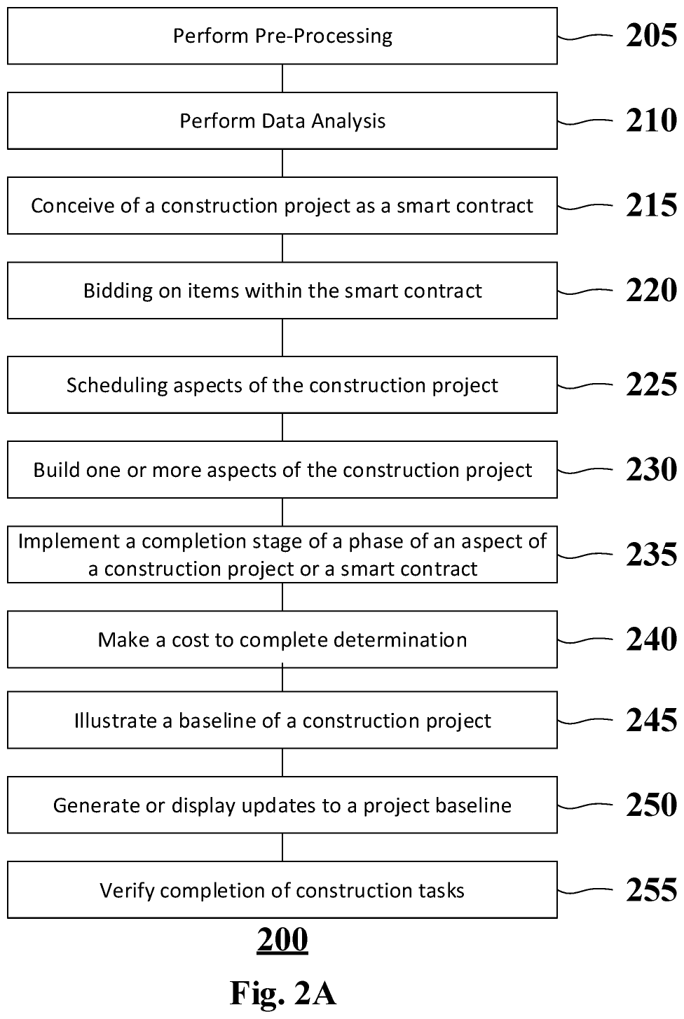

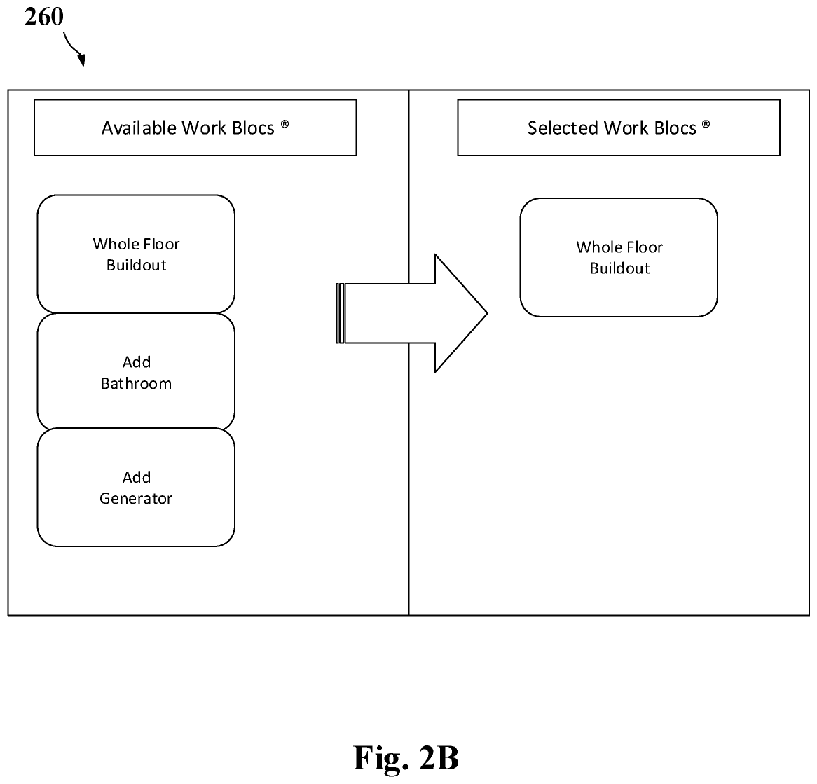

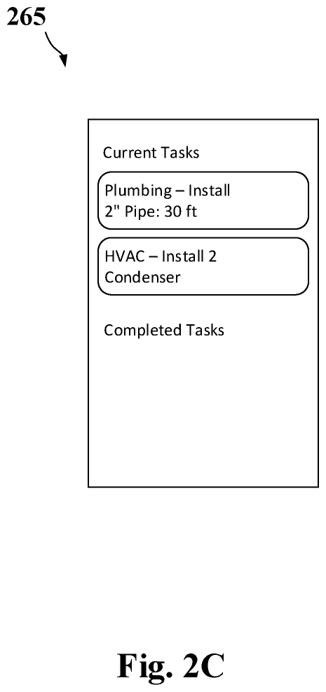

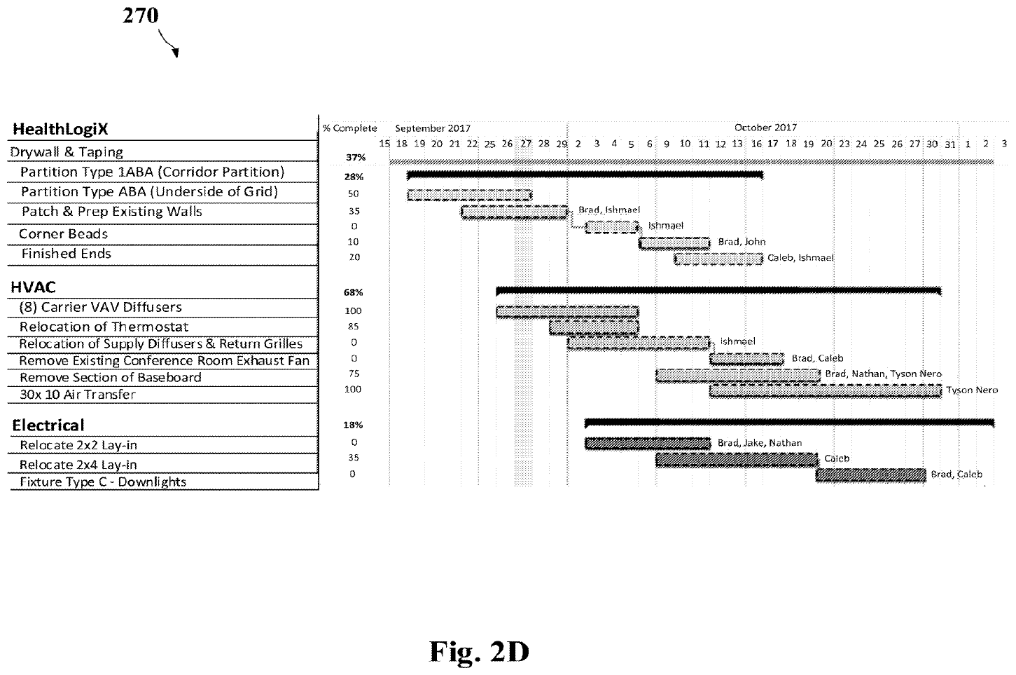

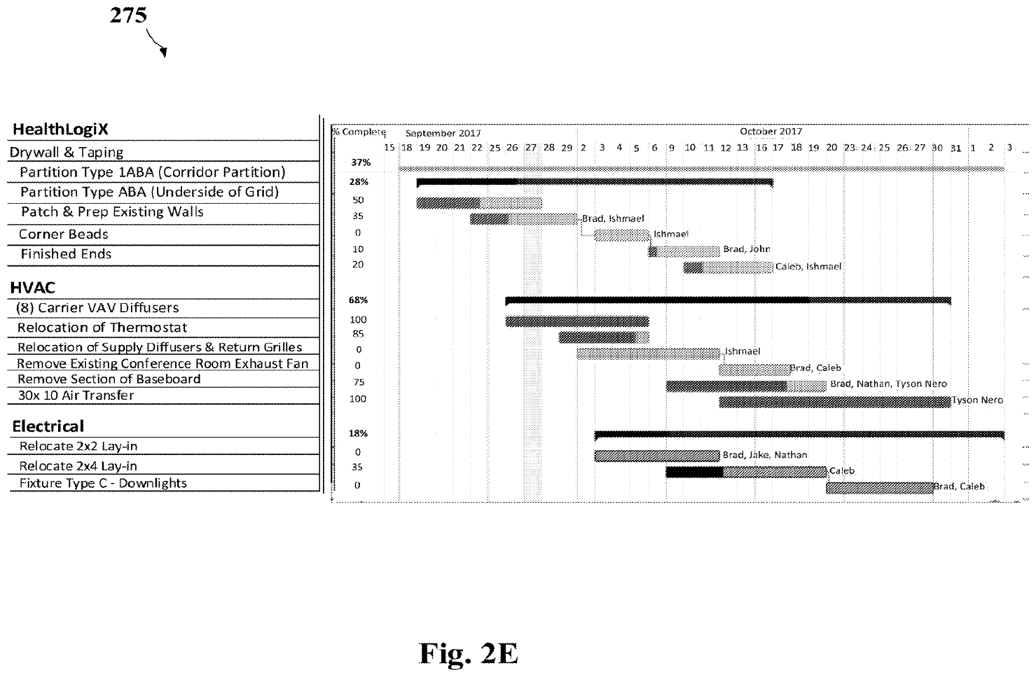

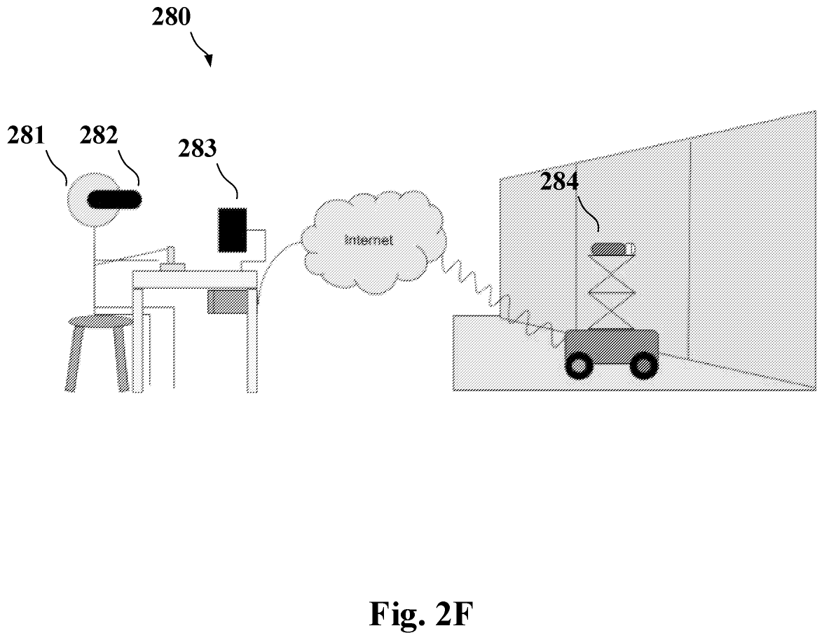

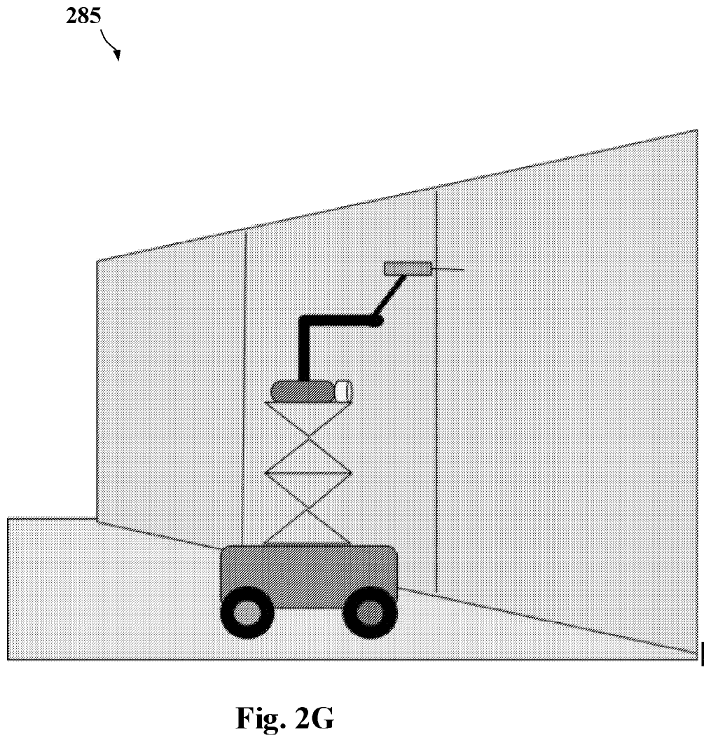

FIG. 2 illustrates an example method according to aspects of the disclosed technology, FIG. 2.

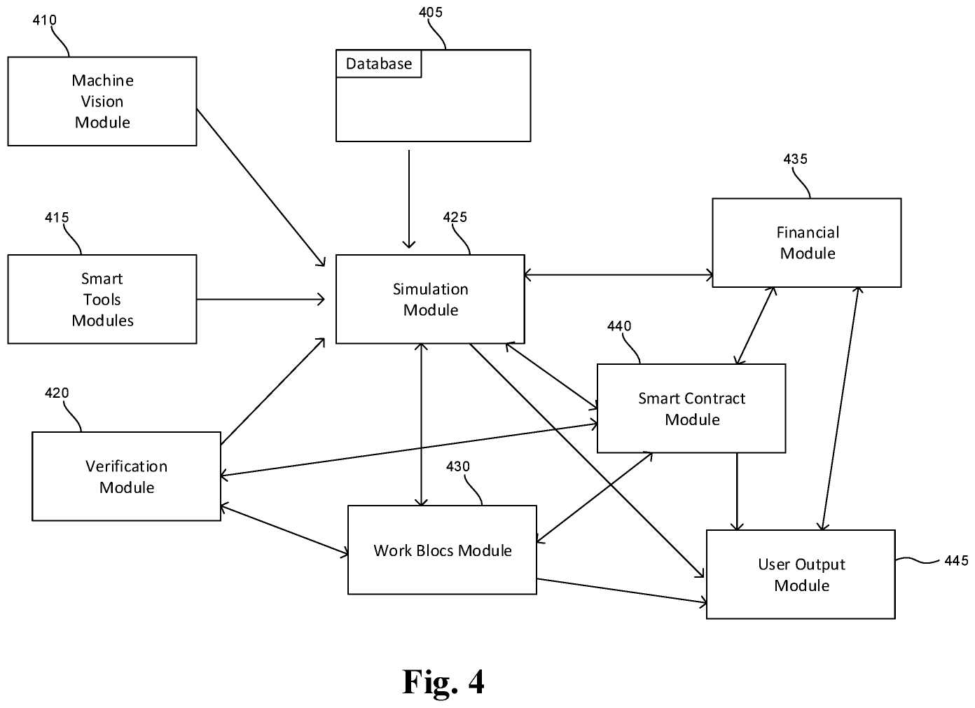

At block 205, pre-processing can occur. Pre-processing can include the selection or establishment of one or more parameters which can be used as input for use in the methods described herein. Data can be collected as workers use a mobile application in real time to record and track project task assignments and status. In some examples, workers can be assigned units of measure (UOM) for tasks along with allowed work hours and the dates for these tasks to be started and completed. The tasks can be any tasks related to the construction project, The assigned dates constitute the expected time a task should take to be completed. Additionally, the application can capture the actual start and finish times as well as the actual UOMs completed along with actual hours worked. In some examples, the information described below can be obtained through input on a mobile application. In some examples, various modules described with respect to FIG. 4 can be used to establish or collect data or parameters. For example, the following can be included as part of block 205:

Inputs

| | |
|---|---|
| 1. | Job ID |
| 2. | Job Type |
| 3. | Worker IDs |
| 4. | Supervisor ID |
| 5. | Task ID |
| 6. | Task Type |
| 7. | Task Sub Type |
| 8. | Task Avg Hrs |
| 9. | Task Duration |
| 10. | Task UOM Cost |
| 11. | Task Allowed Hrs |
| 12. | Task Status |
| 13. | UOM - assigned |
| 14. | UOM - completed |
| 15. | Hours worked |

A person of skill in the art will appreciate that the above examples include some parameters. Many other parameters or data points involved, used, or tracked in a construction project can be configured for collection.

At block 210, data analysis can be performed on data obtained at block 205. Data analysis can be done to refine in relationship to the cost per task UOM. As the worker's cost rate and the actual time taken to complete the UOMs assigned is known, the cost per UOM per task can be refined as new data comes in. Also, the workers' rate of production (ROP) can be calculated. The ROP is a standardized method to compare workers across tasks.

Rate of Production (ROP). In some examples, each worker will have a ROP calculated based on whether they were able to accomplish the work assigned to them on time and their safety record.

For example,

$$ROP = \frac{UOMc}{UOMa} \times {e}^{0. \text{?} \text{?} S}$$

$$\text{?} \text{indicates text missing or illegible when filed}$$

where UOMc is UOMs completed by the worker for a given task, UOMa is the UOMs assigned to a worker for a given task and S is the number of safety incidents that worker has. A person of ordinary skill in the art should understand that although one example is given, the calculation of ROP can be multi-faceted and generated using more sophisticated techniques.

In some examples, the ROP will be further modified to reflect the worker's pay rate and years of experience. As an example, workers can be put into four categories:

| Category | ROP | Pay Rate |
|---|---|---|
| 1 | <1 | High |
| 2 | < or = 1 | Low |
| 3 | >1 | High |
| 4 | >1 | Low |

In some examples, the Pay Rate can be set to High if the worker's pay rate is 10% above the average for the same years of experience and level.

In some examples, the following blocks 215-235 can be used as part of an automatic smart contract. Yet, in other examples, the blocks can be performed in any order as part of method 200.

At block 215, a conception phase of a construction project can be created. At the conception phase, a client for a construction project can describe what needs to be built. The concept of the project can be laid out as it can form the basis of the work and price. The client will be able to select “Work Blocs” that represent their ask for the project. The Work Blocs will be loaded into a smart contract structure to set up for the bid process. In some examples, a Work Bloc can be a discrete construction task which can be described in human interpretable language, such as “add bathroom,” “install generator,” “finish flooring,” “install bathtub,” “replace vanity.” FIG. 2B illustrates some example Work Blocs as they may appear on a user device.

At block 220, a bidding stage can occur. A smart contract can contain all of the request work blocks from block 215 above to be done. A contractor can provide a bid price to the client electronically based on the work block. In some examples, the technology disclosed herein can be used by a contractor to automatically generate an estimated price of completion.

For example, a Work Bloc can be “Build a full bathroom.” This Work Bloc includes tasks such as installing water supply pipes, drain pipes, sink, toilet, bathtub, tiles, and painting the bathroom. When all of the tasks of a Work Bloc are complete and verified as complete, then the smart contract can be configured, upon confirmation of the work being performed, to pay the contractor. As aspects of the Work Block are tracked digitally, the aforementioned can also be entirely automated. In addition, if a particular task is large, such as “install HVAC unit”, that particular task alone can be configured within a smart contract to cause an auto payment. In addition, work verification can be done remotely with a surveillance robot to save time, human resources, and money. Even further, as workers will always know what task to perform next based on algorithms, there is overhead and time saved as a supervisor is not required to authorize or inform workers as to which task needs to be performed next.

At block 225, scheduling can occur. Once the bid is accepted by the client through the smart contract structure, then the scheduling of the work can begin through or displayed on an application disclosed herein. In some examples, a smart contract will include “pay milestones” that will automatically pay the contractor once related elements of construction work as established in the contract are completed. Each task can be scheduled by start date and end date. Additionally, the worker or crew that will perform the task can be determined so that at the end of scheduling resources needed and end date are defined. The duration of the task can be determined by several factors:
1. The higher ROP of the employee assigned to the shorter the task duration;
2. Task duration is automatically adjusted from historical data;
3. The higher the housing density of the location of the task, the longer the task duration for tasks that are sensitive to space requirements;
4. Holidays and manual inputs of extenuating circumstances, such quarantine orders will lengthen the duration;
5. Delays in material orders can lengthen the duration;
6. Weather conditions, which can be related to certain tasks;
7. Geo-Political Factors
   Further, during this block, certain tasks can be designated as milestones in an application and will trigger a payment to the contractor once marked complete. The client will have the option to verify these tasks prior payment and will be given a week to do so. The client will also have access to the finished schedule and be able to follow the project's progress through pictures or video. The schedule will include a confidence factor.

At block 230, building can occur. Once the project is scheduled, a build phase can start. The “Cost to Complete” or other metrics for the project can be continuously updated as tasks are completed and verified. The client can follow along and see how tasks are progressing on a regular basis. In addition, a contractor will be able to see delays and issues as they are happening to address them as quickly as possible to minimize delays to the overall project timeline. Additionally, the technology disclosed herein can learn to schedule tasks and have suggestions ready if tasks are blocked or delayed to keep available resources being utilized towards completing the project. The overarching goal of the build phase can be to adhere to the original completion date and cost. In some examples, the “cost to complete” algorithm can continually or periodically adjust the schedule or completion cost based on information obtained. In some examples, FIG. 2C can be displayed on a user device to indicate current tasks which can be determined according to aspects of the technology described herein. During this phase, information can be obtained from a smarttool as the smarttools are being used.

At block 235 a completion phase can be implemented. Once the final task is completed, then the completion phase can start to close out the smart contract by allowing for final verification by the client and final payment to the contractor. At this phase, additional manual or other checks can be performed.

At block 240, a cost to complete or other completion metric determination can be made.

In some examples, each task for a given project can have a specific amount of UOMs that need to be completed, the allowed hours to complete the UOMs and an assigned worker or crew. The actual hours worked is tracked and deducted from the allowed hours. For example, after calculating the remaining hours for a task, and multiplying by the expected cost per work hour, the remaining cost of the task can be obtained. These remaining hours can then be multiplied by the pay rate of the worker assigned to come up with the remaining labor cost of the task. For tasks assigned to a crew, the labor cost can be the average of the pay rate of all members of the crew multiplied by the hours remaining. If this is done for all of the tasks on a project, then the sum of the remaining costs is the cost to complete for the project.

UOMr=UOMa−UOMc

Hr=HRa−HRc

HRa=allowed hours

Hrc=actual hours

In some examples, if UOMr is negative, then it is set to zero. If Hr is negative then the task is over budget and can be marked as such for the learning machine. Hr is set to the predicted value of the learning machine (HRp) minus the completed hours. The remaining UOMs are multiplied by the cost per UOM (UOM_Cost) for a given task to get the remaining material cost to complete for that task (CTCt) on the project.

Hr=HRp−HRc if HRa>=Hrc

For a given task i:

CTCtᵢ=UOMrᵢ*UOM_Costᵢ+(PRaᵢ*Hrᵢ)

If a crew of P members is assigned to a task then PRa is the sum of all pay rates in the crew:

$${\sum }_{u = 1}^{P} {PRa}_{u}$$

A project can have an arbitrary y number of tasks:

$$Project Cost to Complete ( CTCp ) = {\sum }_{i = 1}^{y} {CTC}_{i}$$

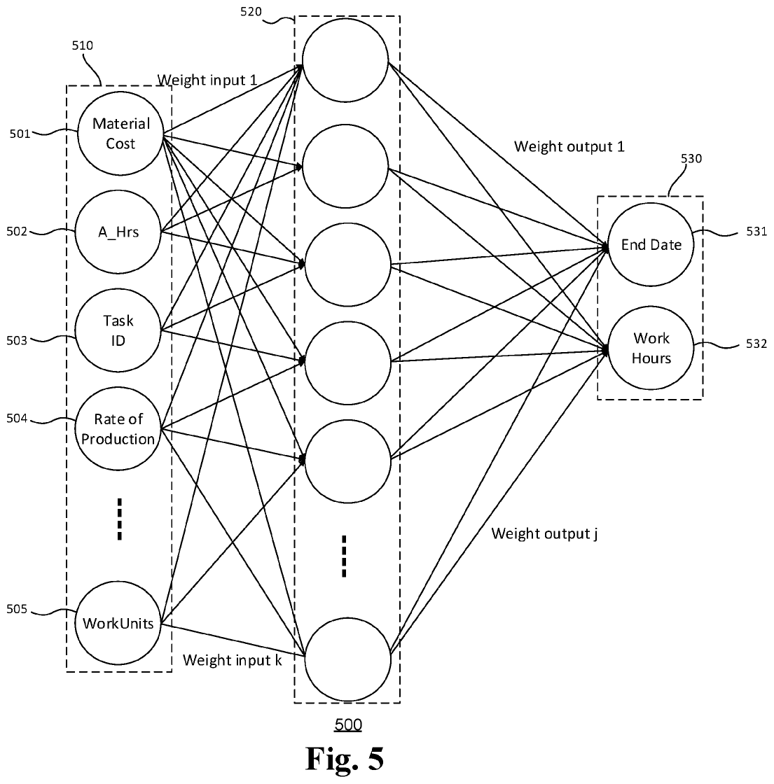

In some examples, machine learning techniques described herein can be used to determine the cost to complete. Any machine learning technique can be used to obtain the cost to complete or to obtain information related to the cost to complete, such as the expected schedule of tasks. A non-limiting example is provided with respect to FIG. 5.

At block 245, a project baseline can be illustrated. When the project is first created, scheduled and workers can be assigned tasks that include the UOM to be done and hours allowed for the work, then initial CTCp can be calculated. This initial CTCp can be saved as the project baseline (CTCpb). As the project progresses and workers update their task completions in real time any deviation can be addressed right away. In some examples, the project display can be illustrated on a device as illustrated in FIG. 2D.

At block 250, updates to the project baseline can be displayed, such as those displayed in FIG. 2E. In-progress tasks and Cost to Complete (“CTC”) updates can be displayed at this block. As workers update the UOMs completed and the database, computing devices, algorithms or applications described herein update hours worked daily (and as the hours remaining for tasks reduce), the CTCp is updated. This can in turn become the real time CTCp or CTCrt. The CTC in real time (CTCrt) is calculated and is compared to the baseline for the project to determine any areas needing further investigation. This method is an improvement from the current situation where this review is only done by human intervention at fixed intervals, where it becomes infeasible to address issues.

At block 255, tasks completion can be verified manually or automatically using computer vision techniques.

In some examples, task verification can be manual. When a worker completes a task, it is sent to the project supervisor for verification. Once the task update is verified, then the Cost to Complete can be updated.

In some examples, task verification can be automated. For example, construction worksites can have remote controlled robots that will be used to determine task completion, such as displayed with respect to FIG. 2F. The robot can link to a network or a server through a 4G, 5G or WiFi connection. A person from an office setting can control a robot and inspect the work done on site. To help with spatial orientation, the remote operator uses a Virtual Reality (VR) headset and controls the robot's movements directly. If the link is broken for a specified amount of time, the robot will return to its original location autonomously. With reference to the figure ahead, such an example is illustrated. As an example, drywall board installation is an example where the picture uploaded by the worker/supervisor can be scanned by a trained computer vision algorithm to detect gaps and other installation issues.

In some examples, if a task is completed by a robot then it is automatically verified as complete and the project CTC is updated. As an example, once the robot is done drilling sheetrock boards, that task is marked complete and the CTC for the project is updated. For example, the autonomous robot illustrated in FIG. 2G can be used in such an example.

While operations are depicted in the above method and in drawings in a particular order, this should not be understood as requiring that such operations be performed in the particular order shown or in sequential order, or that all illustrated operations be performed, to achieve desirable results. In certain circumstances, multitasking and parallel processing may be advantageous.

In some examples, additional processing can occur or analysis can occur with respect to FIG. 2.

FIG. 2B illustrates an example display of available work blocks as they may be displayed on a user device, interface 260. The user device may be a device owned by a contractor or sub-contractor who has the ability to select a particular work block for performance of one or more tasks described in the work block. In some examples, selection of a work block by a user on a user device can cause a smart contract to be initiated or selected. In other examples, completion of a work block and verification of the same can cause automatic payment to the contractor or sub-contractor and updating the cost-to-complete algorithm and/or schedule related to work blocks.

FIG. 2C illustrates example “completed tasks” from work blocks in interface 265. Interface 265 can display current tasks which a contractor, sub-contractor, employee, or construction agent has completed.

FIG. 2D illustrates an example schedule 270 which can be displayed on a user device. In some examples, schedule 270 can be generated based on work blocks and relationships between work blocks and can be a “baseline” schedule.

FIG. 2E, similar to FIG. 2D, illustrates an example schedule 275 which can reflect updates or completions to the schedule based on user inputs or a calculation of a percentage of an event being completed.

FIG. 2F illustrates a schematic view of a user viewing a work site through a virtual reality headset. A user 281 can connect to and access the view of a tool 284 through a virtual reality headset 282 connected through a user device 283. Tool 284 can be capable of being remotely controlled through the user device 283 and connected via the internet.

FIG. 2G illustrates a robot 285. Robot 285 can be an example of construction device 25 or a smart tool. Robot 285 can be autonomous or semi-autonomous. In some examples, as robot 285 performs or conducts tasks, information related to the completed tasks can be sent from robot 285 to a database or other module described with reference to FIG. 4 for analysis and updating the cost-to-complete algorithm. As example capabilities of robot 285, robot 285 can have a sensor to detect how level tiles are after installation. Robot 285 can also have a camera with a LIDAR sensor or other sensor to detect depth. Using the depth information, robot 285 can obtain a room or construction site's dimensions autonomously or semi-autonomously and detect issues with plastering, brick, drywall installation, or other construction tasks. This information can be used to make determinations by the processes described herein. In other examples, other devices with sensors or cameras, such as for example, a smart phone with a LIDAR sensor can also be used with the applications or examples described herein.

FIG. 3 depicts a block diagram of an example computing device 300. The computing device 300 may include one or more processor(s) 310, system memory 320, a bus, and networking interface(s). Computing device 300 may also contain other components (not shown), such as storage(s), output device interface(s), input device interface(s). A bus may be used for communicating between the processor 310, the system memory 320, the networking interface(s), and other components of computing device 300. Any or all components of computing device 300 may be used in conjunction with the subject of the present disclosure.

In some examples, the processor 310 may be of any type, including but not limited, to a central processor unit, a tensor processing unit (TPU), a microprocessor, a microcontroller, a digital signal processor (DSP), or any combination thereof. The processor 310 may include one more level of caching, such as a level one cache 311 and a level two cache 312, a processor core 313, and registers 314. The processor core 313 may include one or more arithmetic logic unit (ALU), one or more floating point unit (FPU), one or more DSP core, or any combination thereof. A memory controller 315 may also be used with the processor 310, or in some implementations the memory controller 315 can be an internal part of the processor 310. In some examples, the processor 310 can be a machine learning accelerator.

The physical memory 320 may be of any type including but not limited to volatile memory, such as RAM, non-volatile memory, such as ROM, flash memory, etc., or any combination thereof. The physical memory can include an operating system 321, one or more applications 322, and program data 324, which may include service data 325. Non-transitory computer-readable medium program data 324 may include storing instructions that, when executed by the one or more processing devices, implement a process for computing the result of a multiply and accumulate operation 323. In some examples, the one or more applications 322 may be arranged to operate with program data 324 and service data 325 on an operating system 321. Physical memory 320 may be an example of computer storage media. Computer storage media includes, but is not limited to, RAM, ROM, EEPROM, flash memory or other memory technology, or any other medium which can be used to store the desired information and which can be accessed by computing device 300. Any such computer storage media can be part of the device 300.

The computing device 300 may have additional features or functionality, and additional interfaces to facilitate communications between and among any required devices and interfaces.

Network interface(s) 340 may couple the computing device 300 to a network (not shown) and/or to another electronic device (not shown). In this manner, the computing device 300 can be a part of a network of electronic devices, such as a local area network (“LAN”), a wide area network (“WAN”), an intranet, or a network of networks, such as the Internet. In some examples, the computing device 300 may include a network connection interface for forming a network connection to a network and a local communications connection interface for forming a tethering connection with another device. The connections may be wired or wireless. The computing device 300 may bridge the network connection and the tethering connection to connect the other device to the network via the network interface(s) 340.

The computing device 300 may be implemented as a portion of a small form factor portable (or mobile) electronic device such as a speaker, a headphone, an earbud, a cell phone, a smartphone, a smartwatch, a personal data assistant (PDA), a personal media player device, a tablet computer (tablet), a wireless web-watch device, a personal headset device, a wearable device, an application-specific device, or a hybrid device that include any of the above functions. The computing device 300 may also be implemented as a personal computer including both laptop computer and non-laptop computer configurations. The computing device 300 may also be implemented as a server, an accelerator, or a large-scale system.

FIG. 4 illustrates an example architecture according to aspects of this disclosure.

Illustrated in FIG. 4 is a database 405, a machine vision module 410, a smarttools module 415, a verification module 420, a simulation module 425, a work block module 430, a financial module 435, a smart contract module 440, and a user output module 445.

Database 405 can contain information related to one or more construction projects, tasks to be completed, equipment available, materials, workers, historical information about projects, worker efficiencies, or any other data which can be used by a simulation module or other trained machine learning or other algorithmic model to predict information about related to a construction project. For example, database 405 may contain a relational database containing information described within this disclosure. Any other database structure can also be used. In some examples, information obtained from any of the modules described with respect to FIG. 4 can be stored within database 405.

Machine vision module 410 can contain one or more software and/or hardware components which allow for analysis of construction sites. For example, machine vision module 410 can contain software which can process image or video information which may be obtained from a construction site. For example, a machine vision module can be configured to take a picture of a particular area of a construction site and process the image to provide information related to the job site. In some examples, the machine vision module can be provided with metadata related to the visual information it is being provided, such as a stage in construction or a related work block. Machine vision module 410 can use the metadata to determine which type of information or characteristics to search for based on the provided metadata. For example, during a “sheetrocking” stage, the machine vision module 410 can determine the tightness of sheetrock installation, the presence of sheetrock tape between sheetrock, the number of sheetrock screws, the distance between sheetrock screws, and other characteristics to determine the percentage of work completed within a work block. As another example, machine vision module 410 can be provided visual data of a roof and analyze the percentage of roofing done. As yet another example, the machine vision module 410 can be provided a picture or video of a shower and optionally provided metadata related to the work block being associated with the shower. The machine vision module 410 can analyze the video for completeness of tiling within the shower, the type of tile, and the fit and finish of the tile. For example, machine learning module 410, or other modules, can include a brick counting algorithm, drywall installation error detection algorithm, or a framing error detection algorithm to detect information related to various construction tasks. In other examples, a tile installation error detection algorithm and “on-site” material counting algorithm can be included to obtain information about errors in tile installation and available materials on-site for planning purposes. In yet other examples, work attendance of particular workers can be provided based on facial recognition.

Smarttools module 415 can obtain information from one or more smarttools which may be used on a construction site. In some examples, certain tools used on a construction project can communicate via a communication link to provide information to simulation module 425. In other examples, certain tools or machinery can be provided with a high priority to indicate that information obtained from those tools or machinery is considered to be entirely reliable and can be used without further verification by simulation module 425. In other examples, information provided by smarttools module 415 can obtain or provide information related to a construction project as described in this disclosure. For example, smarttools module 415 can aggregate information from multiple tools or machinery used or associated with a construction job which can be used as inputs to train a machine learning model or used to approximate the amount of work completed on a work block. For example, a particular work block may require a specified number of activities or tasks to be completed (e.g., number of screws, number of tiles, number of floor planks) Smarttools module 415 can aggregate data related to the tasks based on input from multiple smarttools on the job site.

Verification module 420 can contain software components which enable a user to provide information on work blocks which may be completed. In some examples, verification module 420 can include one or more algorithms which can take inputs from human operators (e.g., inputting information through an application by a manager or supervisor), inputs from one or more smarttools, or include or take input or generate data using a computer vision or natural language interpretation algorithm or module. Verification module can also contain algorithms to generate a checklist or other list of activities which need to be verified in connection with completing a task. Verification module can also communicate with any of the modules described with respect to FIG. 4.

Simulation module 425 can obtain information from various modules and simulate a workflow. In some examples, simulation module 425 can take as inputs any combination of as input work blocks, smart contracts related to work blocks, and construction data related to various modules described with respect to FIG. 4 and provide as an output any of (i) work blocks, (ii) financial estimations for a construction project, (iii) summary information related to current and anticipated timelines for a construction project.

In some examples, simulation module 425 can contain trained machine learning modules which can take multiple inputs to simulate or generate information related to the construction project. Historical data can be used to train an algorithm to predict the duration of tasks in hours and days. The training can be done in a simulation mode and the trained algorithm can be used through an application when being used on a construction project. Inputs can be simulated from various tools and other data sources during the training process.

Work block module 430 can contain information related to various work blocks related to the construction project. In some examples, work block module 430 can take information related to an overall construction task (e.g., build shed, build house) and contain discrete construction tasks which can be described in human interpretable language, such as “add bathroom,” “install tub” or “add roof.” In some examples, a work block can be further discretized into smaller tasks which can be interpretable by a machine, such as “insert screw” at a specified coordinate, and allowing for automation of aspects of the construction project. In some examples, work block module 430 can be generated from an overall blueprint of specific construction specifications of a construction project. In some examples, the generation of work blocks can take place based on trained machine learning modules which have been trained on a prior set of construction specifications (e.g., size, type of construction, number of bathrooms, layout, number of rooms, flooring specifications, dimensions) and an associated set of work blocks. In some examples, multiple potential sets of work blocks can be generated and work block module 430 can interact with simulation module 425 to choose a specific set of work blocks based on user preferences, cost savings, time savings, criticality of construction projects, or changing material costs. In some examples, work blocks can also contain timing, priority, or relate to other work blocks to determine an order in which work blocks can be completed.

Financial module 435 can provide a financial simulation of expected costs of the construction project. Financial module 435 can use an output from simulation module 425 to estimate the total cost of the construction project. In some examples, financial module 435 can provide an estimated future cost based on the current state of the construction project.

Smart contract module 440 can contain information about one or more smart contracts which are associated with a construction project and related to one or more work blocks related to the construction project. Smart contract module 440 can allow for the generation of one or more smart contracts based on work blocks. In some examples, smart contract module 440 can automatically generate one or more smart contracts while in other examples smart contract module 440 can allow for the manual addition of smart contracts by authorized users. In some examples, smart contract module 440 can be in communication with financial module 435 and allow for the automatic payment to subcontractors upon the conditions within a smart contract (e.g., completion of a work block) being met. In some examples, smart contract module 440 can also obtain up to date information from a financial module to reflect changing costs of raw materials, labor costs, or other information, and reflect the variable price within the smart contract.

In other examples, information in the smart contract module can be included within a blockchain and be output to a blockchain. In some examples, information about the construction project can be included in the block chain and stored in a blockchain ledger related to the project. For example, the materials used, contractors and subcontractors used, workers who worked on the project, and source of materials can be included in the blockchain. An existing general purpose blockchain, such as the Ethereum blockchain, or a specific purpose blockchain can be used as part of the smart contract. The smart contract and blockchain can be used to verify the existence of deposits and money for payment of the smart contracts as work is completed and confirmed. In addition, the blockchain can be used to ensure that the smart contracts are not tampered with and that each smart contract is unique, and can only be assigned or completed by one entity.

User output module 445 can summarize information related to the construction project which is obtained or derived from any of the blocks described with respect to FIG. 4. In some examples, user output module 445 can include rules to provide only certain aspects of information related to the construction project to third parties based on a set of privacy rules. As one example, an insurance company involved in the construction project may desire to know the current construction status of the project but a builder or contractor may not desire to share particular materials used or financial costs of the project. User output module 445 can summarize this information and share with a particular user based on rules within a database.

### Example Machine Learning Techniques, Example Algorithms, Definitions, and Formulations

The following examples can be used as methods, algorithms, or techniques to carry out the methods disclosed herein. A person of skill in the art will appreciate that these techniques are illustrative and non-limiting, and that other variations, combinations, and alternatives to these illustrative techniques can be applied without departing from the scope of the disclosure.

Any number of machine learning techniques can be used in conjunction with the methods described herein. One example machine learning technique is described with respect to FIG. 5. FIG. 5 illustrates a convoluted neural network (CNN) 500. Neural network 500 can contain a number of inputs in an input layer 500, such as for example, inputs 501-505, an output layer, 530, with a number of outputs, such as outputs 531-532, and a number of middle layers, such as middle layer 520. Middle layer 520 can contain an arbitrary number of nodes which have not been labeled for clarity. Additionally, although only a single middle layer 520 is illustrated in FIG. 5, neural network 500 can contain a number of middle layers.

In some examples, the information obtained in output layer 530 can be used by other algorithms to determine a cost to complete. Determinants of cost to complete typically include the project end date and work hours needed. If these two parameters can be accurately estimated at the project's start it can greatly reduce the issues currently faced in the construction industry. \Using reinforcement learning the weights between the layers of CNN 500 can be updated to determine the most crucial inputs and provide accurate results.

In some examples, input layer 510 can include the following non-limiting and exemplary information. Input_Layer:

| | | | | | Work Unit |
|---|---|---|---|---|---|
| Material $ | A_Hours | Location | Task ID | Work Units | Type |
| Calendar | ROP | Stoppage | Weather | Attendance | Pay Rate |

In some examples, output layer 530 can include the following non-limiting and exemplary information. Output_Layer:

| | |
|---|---|
| Work Hours | End Date |

For every connection between the input layer 510 and middle layer 520 weight values can be calculated. Similarly, there are weights for every connection from the middle layer to the outputs. FIG. 5 illustrates these as weight input 1 and weight input k, and weight output 1 and weight output j. Any arbitrary number of inputs and outputs can be used. For example, if more inputs are deemed necessary in future versions, additional weights and middle layers can be added to CNN 500. In some examples, the output results of the neural network can be checked or trained against real-value results collected or obtained through input on a user application. CNN 500 can thus be trained to adjust the weights between the various layers and nodes of the neural network. The output results are checked against actual results collected by a user application which can store or organize the evaluated metrics or outputs, and the weights are updated accordingly to match the results. This reinforcement of the results during the learning phase gives a set of weight values to be used in a user application or an algorithm which can be used to make predictions. This set of weights will give real time accurate results of work hours needed and end date of any construction project with known tasks. Additionally, the weight values can be specific or chosen based on information related for a project, company, trade, or an industry. Thus, different weight values can be chosen or used based on user preferences or information known about the construction project. The information from the output layer can be further analyzed or used in other algorithms or as inputs to other machine learning models to calculate additional construction related metrics.

A person of skill in the art will appreciate that the example given with respect to FIG. 5 is exemplary, and that other machine learning techniques can be used. In some examples, a mix of supervised learning techniques and unsupervised learning techniques can be used. In some examples, generative adversarial networks can be used to predict or detect network anomalies. Generative adversarial networks use two networks, one adversarial and one generative, in an attempt to fool the adversarial network by objects generated by the generative network.

Some other examples of techniques include dimensionality reduction. Dimensionality reduction can be used to remove the amount of information which is least impactful or statistically least significant. One example dimensionality reduction method is principle component analysis (PCA). PCA can be used to reduce the dimensions or number of variables of a “space” by finding new vectors which can maximize the linear variation of the data. PCA allows the amount of information lost to also be observed and for adjustments in the new vectors chosen to be made. Another example technique is t-Stochastic Neighbor Embedding (t-SNE).

Ensemble methods can be used, which primarily use the idea of combining several predictive models, which can be supervised ML or unsupervised ML to get higher quality predictions than each of the models could provide on their own. As one example, random forest algorithms Neural networks and deep learning techniques can also be used for the techniques described above. Neural networks generally attempt to replicate the behavior of biological brains in turning connections between an input and output “on” or “off” in an attempt to maximize a chosen objective.

### Reinforced Learning Techniques to Create Action Recommendations

The following example variables or descriptions can be used in conjunction with task scheduling generation or workflow recommendations.

Environment—Consists of tasks within the context of a project and schedule. Tasks are also assigned to individuals. In this environment tasks can be rescheduled and/or reassigned. For the purpose of the algorithm here, projects will be non-changeable.

Agent—the agent in the algorithm will behave similar to a supervisor on a project. It will have the ability to reschedule and reassign tasks within a given project. The goal of the agent is to finish all of the tasks for a project with the lowest cost and on time.

Actions (A)—the algorithm will be able to reschedule or re-assign a task.

State (S)—a state is the current situation the algorithm is assessing. From this state it will figure out the best action to take and move to another state.

Reward (R)—a feedback for the algorithm that will indicate a successful or failed action. The algorithm will use the reward system to learn what is the best action for a given state.

Discount factor (γ)—a factor used to multiply R so that future rewards are worth less. This will cause more exploration to find alternate routes to the end goal.

Policy (π)—the strategy that will be developed by the algorithm during the exploration phase to be used in real life practice (exploitation) phase

Value (V)—the expected long-term return with discount of the currency state under the current policy

Q-Value (Q)—the expected value for a given action. The results here are action-value pairs for a given state.

Trajectory—a sequence of states and actions.

### Task Scheduling Recommendations

Currently, scheduling for a construction project is done manually. A reinforced learning algorithm can be trained from experience and through experimentation can determine a path forward to completing the project in cases where work is stalled. Once the algorithm is sufficiently trained, it can be used on all projects. An example state in the algorithm can be that a framing task needs to be put on hold for inspection. The algorithm will look at the remaining tasks on the project and suggest to the supervisor that a plumbing task can be moved up in the schedule while the framing inspection is completed. The suggestions are based on a policy created from reinforced learning on prior experiences and experimentation by the algorithm itself. The object of the algorithm is to reduce down time on the project.

Actionᵢ₊₁<=Policy(Stateᵢ)

### Generating Task Suggestion Policy

The environment for the algorithm is defined by the tasks available for a project and the workers available. The experimentation agent can be rewarded for keeping resources on a task when there are tasks to complete and inversely penalized when letting tasks sit idle or losing resources outright. Using the reward/penalty procedure the agent can train itself through experimentation to come up with a policy. Additionally, the policy can be updated from additional data which can form a database of already implemented examples. The resultant policy can be used (exploited) on real construction projects. In some examples, multiple paths can be generated and then screened using other machine learning techniques. For example, the algorithm can learn from a “good” supervisor what to do during specific scenarios. Reinforced learning can be used to teach the algorithm because we have data from previous projects of how schedules were rearranged to deal with delays. Once the algorithm, which can include a convoluted neural network (CNN), is trained, the algorithm can then provide task adjustments in real time to help with projects.

In some examples, the machine learning and related techniques described above can be used as part of the generation of task suggestions.

The starting state of the agent is when a task is put on hold or delayed. The actions that the algorithm can take are to move up another task in schedule, move resources to other tasks within the project and do nothing. During the learning process vectors will be created where the algorithm will execute all actions from a starting state and add up the rewards/penalties to project completion for each action. The vectors will be analyzed and the best result will be saved to the policy.

Once the policy is mature with state action pairs it will become the exploitation agent and used on real projects. If the agent comes across a state that it does not have an action for it will do nothing and report to the experimentation agent so one can be generated. The two agents will work together to cover all states.

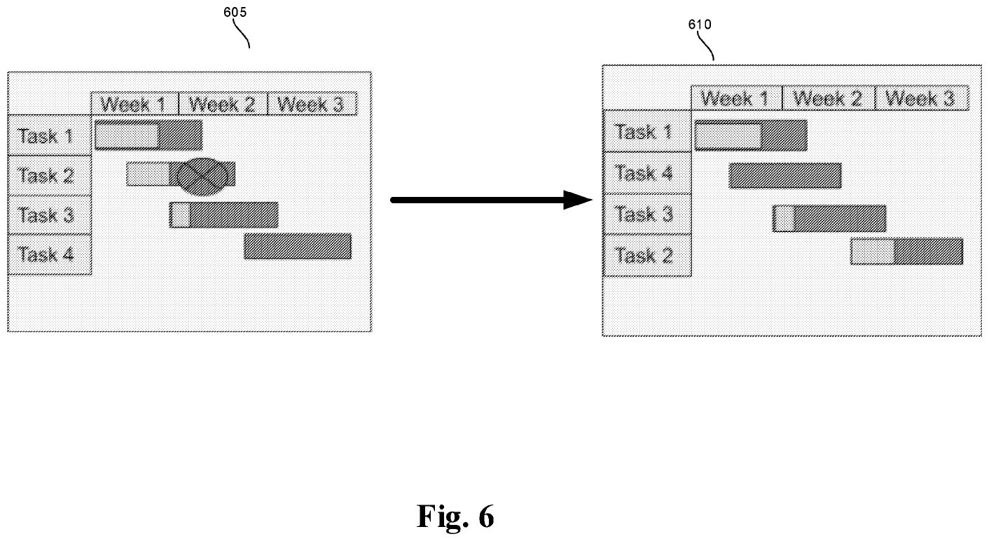

FIG. 6 illustrates a visual representation of an example adaption through the experimentation agent. FIG. 6 illustrates graph 605, which reflects various tasks at various timelines, and the generation of graph 610, by adapting to a change in the tasks when task 2 cannot be completed and the order of tasks is changed. Graph 610 or information contained therein can be generated using machine learning techniques based on inputs or variables described in this disclosure.

While this disclosure contains many specific implementation details, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Aspects of the disclosed technology can include any combination of the following features:

Feature 1. A method of determining a completion metric for a construction activity, the method comprising:
selecting, one or more parameters related to a construction activity;
receiving, by one or more processors, a current condition of a construction project;
determining, by the one or more processors, from possible tasks, a scheduled sequence of tasks to complete the construction activity;
evaluating, by the one or more processors, a current status of at least one task from the schedule of tasks; and
computing, by one or more processors, the completion metric for the construction project based on the current condition of the construction project and the current status of at least one task from the schedule sequence of tasks.
   Feature 2. The method of feature 1 wherein the determination is made based on at least one of: (i) a machine learning algorithm, (ii) a generative adversarial network, or (iii) a trained neural network.
   Feature 3. The method of features 1-2 further comprising updating the completion metric upon receiving an indication that a task from a schedule of tasks is completed.
   Feature 4. The method of features 1-3 further comprising updating the completion metric upon receiving an indication that a task from a schedule of tasks cannot be completed.
   Feature 5. The method of features 1-4 further comprising updating the scheduled sequence of tasks related to the construction activity.
   Feature 6. The method of feature 1-5 wherein a smart contract is associated with one or more tasks from the scheduled sequence of tasks.
   Feature 7. The method of features 1-6 further comprising executing the smart contract upon completion of a task within the scheduled sequence of tasks.
   Feature 8. The method of features 1-7 wherein execution of the smart contract pays an entity associated with the completion of the task within the scheduled sequence of tasks.
   Feature 9. The method of feature 3 wherein verification of completion of a task from the scheduled sequence of tasks is based on data obtained from a smarttool.
   Feature 10. The method of feature 3 wherein verification of completion of a task from the scheduled sequence of tasks is based on data generated using a computer vision technique.
   Feature 11. The method of features 1-10 comprising generating a work block for each task from the one or more schedule of tasks.
   Feature 12. The method of features 1-11 wherein the completion metric is a cost to complete or a time to complete the construction activity.
   Feature 13. The method of features 1-12 wherein evaluating the current task is based on information received from a construction device, smarttool, data generated from a natural language interpretation algorithm, or data generated from a machine vision algorithm.
   Feature 14. The method of features 1-13 comprising revising the sequence of tasks upon evaluation of the current task.
   Feature 15. The method of features 1-14 wherein the revision of the sequence of tasks is performed by an experimentation agent.
   Feature 16. A system comprising one or more processors coupled to a memory, the memory containing instructions to determine a completion metric for a construction activity, the instructions when executed configured to perform the steps of:
selecting, one or more parameters related to a construction activity;
receiving, by one or more processors, a current condition of a construction project;
determining, by the one or more processors, from possible tasks, a scheduled sequence of tasks to complete the construction activity;
evaluating, by the one or more processors, a current status of at least one task from the schedule of tasks; and
computing, by one or more processors, the completion metric for the construction project based on the current condition of the construction project and the current status of at least one task from the schedule sequence of tasks.
   Feature 17. A method of generating a completion metric related to a construction project by using a trained neural network, the method comprising:
receiving, in an input layer of the neural network, one or more inputs related to the construction project, the one or more inputs including at least information obtained from (i) a smarttool or (ii) a machine vision algorithm;
evaluating, through a middle layer, the received one or more inputs; and outputting, in an output layer, one or more outputs from which a completion metric can be generated, the one or more outputs comprising at least one of (i) an end date or (ii) estimated remaining work hours;
wherein the trained neural network was trained on historic data related to the output layer to generate weights for connections between the input layer and the middle layer and between the middle layer and the output layer.
   Feature 18. The method of feature 17 wherein the trained neural network is chosen based on the type of construction project.
   Feature 19. The method of features 17-18 comprising generating a completion metric by evaluating all outputs of the output layer.
   Feature 20. The method of features 17-19 comprising generating the completion metric upon completion of a work block, a task, or a sub-task.
   Feature 21. A method, computer readable medium, or system of establishing a cost to complete for a construction activity, the method, computer readable medium, or system comprising any combination of the following steps:
selecting, one or more parameters related to a construction activity;
receiving, by one or processors, a current condition of a construction project;
receiving, by at least one smarttool based information related to at least one selected parameters;
determining, by one or more processors, a cost to completion of the construction project wherein the determination is based on at least one of: (i) a machine learning algorithm, (ii) a generative adversarial network, or (iii) a trained neural network;
determining, by the one or more processors, a schedule of tasks related to the construction activity;
determining, by the one or more processors, instructions related to the determined schedule of tasks wherein the instructions are machine-readable;
sending, from the one or more processors, instructions to an autonomous construction apparatus, wherein the apparatus is one of a (i) robot or autonomous construction equipment;
sending, from the one or more processors, the cost to complete the construction activity to a user device;
and wherein the one or more processors are configured to be in data communication with a smart construction device.
   Feature 22. A computer readable medium storing instructions, the instructions when executed configured to perform any combination of the following:
selecting, one or more parameters related to a construction activity;
receiving, by one or more processors, a current condition of a construction project;
receiving, by at least one smarttool information related to at least one selected parameters;
determining, by one or more processors, a cost to completion of the construction project wherein the determination is based on at least one of: (i) a machine learning algorithm, (ii) a generative adversarial network, or (iii) a trained neural network;
determining, by the one or more processors, a schedule of tasks related to the construction activity;
determining, by the one or more processors, instructions related to the determined schedule of tasks wherein the instructions are machine-readable;
sending, from the one or more processors, instructions to an autonomous construction apparatus, wherein the apparatus is one of a (i) robot or autonomous construction equipment;
sending, from the one or more processors, the cost to complete the construction activity to a user device;
and wherein the one or more processors are configured to be in data communication with a smart construction device.

1. A method of determining a completion metric for a construction activity, the method comprising:
receiving, by one or more processors, a current condition of a construction project;
determining, by the one or more processors, from possible tasks, a scheduled sequence of tasks to complete the construction activity;
evaluating, by the one or more processors, a current status of at least one task from the schedule of tasks; and
computing, by one or more processors, the completion metric for the construction project based on the current condition of the construction project and the current status of at least one task from the schedule sequence of tasks.

2. The method of claim 1, wherein determining is made based on at least one of: (i) a machine learning algorithm, (ii) a generative adversarial network, or (iii) a trained neural network.

3. The method of claim 1, comprising updating the completion metric upon receiving an indication that a task from a schedule of tasks is completed.

4. The method of claim 1, comprising updating the completion metric upon receiving an indication that a task from a schedule of tasks cannot be completed.

5. The method of claim 1, comprising updating the scheduled sequence of tasks related to the construction activity.

6. The method of claim 1, wherein a smart contract is associated with one or more tasks from the scheduled sequence of tasks.

7. The method of claim 6, comprising executing the smart contract upon completion of a task within the scheduled sequence of tasks.

8. The method of claim 7, wherein execution of the smart contract pays an entity associated with the completion of the task within the scheduled sequence of tasks.

9. The method of claim 3, wherein verification of completion of a task from the scheduled sequence of tasks is based on data obtained from a smarttool.

10. The method of claim 3, wherein verification of completion of a task from the scheduled sequence of tasks is based on data generated using a computer vision technique.

11. The method of claim 1, comprising generating a work block for each task from the one or more schedule of tasks.

12. The method of claim 1, wherein the completion metric is a cost to complete or a time to complete the construction activity.

13. The method of claim 1, wherein evaluating the current task is based on information received from a construction device, smarttool, data generated from a natural language interpretation algorithm, or data generated from a machine vision algorithm.

14. The method of claim 13, comprising revising the sequence of tasks upon evaluation of the current task.

15. The method of claim 14, wherein the revision of the sequence of tasks is performed by an experimentation agent.

16. A system comprising one or more processors coupled to a memory, the memory containing instructions to determine a completion metric for a construction activity, the instructions when executed configured to perform the steps of:
selecting, one or more parameters related to a construction activity;
receiving, by one or more processors, a current condition of a construction project;
determining, by the one or more processors, from possible tasks, a scheduled sequence of tasks to complete the construction activity;
evaluating, by the one or more processors, a current status of at least one task from the schedule of tasks; and
computing, by one or more processors, the completion metric for the construction project based on the current condition of the construction project and the current status of at least one task from the schedule sequence of tasks.

17. A method of generating a completion metric related to a construction project by using a trained neural network, the method comprising:
receiving, in an input layer of the neural network, one or more inputs related to the construction project, the one or more inputs including at least information obtained from (i) a smarttool or (ii) a machine vision algorithm;
evaluating, through a middle layer, the received one or more inputs; and
outputting, in an output layer, one or more outputs from which a completion metric can be generated, the one or more outputs comprising at least one of (i) an end date or (ii) estimated remaining work hours;
wherein the trained neural network was trained on historic data related to the output layer to generate weights for connections between the input layer and the middle layer and between the middle layer and the output layer.

18. The method of claim 17, wherein the trained neural network is chosen based on the type of construction project.

19. The method of claim 17, comprising generating a completion metric by evaluating all outputs of the output layer.

20. The method of claim 17, comprising generating the completion metric upon completion of a work block, a task, or a sub-task.
